(19) United States
(12) Patent Application Publication
(10) Pub. No.: US 2009/0269246 A1
(43) Pub. Date: Oct. 29, 2009

(54) Specimen sampling liquid container

(76) Inventor: Mitsuru Hasegawa, Osaka-fu (JP)

Correspondence Address: KUBOVCIK & KUBOVCIK, SUITE 1105, 1215 SOUTH CLARK STREET, ARLINGTON, VA, 22202, US

(21) Appl. No.: 11/921,559

(22) PCT Filed: Apr. 27, 2006
(86) PCT No.: PCT/JP2006/308853

§ 371 Date: Jan. 12, 2009

(30) Foreign Application Priority Data
Jun. 8, 2005 (JP) 2005-168293

(51) Int. Cl. B01L 3/00

(52) U.S. Cl. 422/102

(57) ABSTRACT

A specimen sampling liquid container which eliminates the risk of an inspector being contaminated or infected with a virus and the drawback of troublesome workability. The specimen sampling liquid container comprises a bottomed tubular container having an open upper end, a sealing member for closing the opening in the tubular container, and a cap provided with a member engaging with the upper end of the tubular container at a first position, capable of being moved from the first position to a second position, receiving the sealing member, having a drip opening at the upper end, and releasing the sealing member to below the drip opening, wherein the sealing member for closing the opening in the tubular container is released when the cap is slid from the first position to the second position, thus allowing the drip opening of the cap and the tubular container to communicate with each other.

### TECHNICAL FIELD

The present invention relates to a specimen sampling liquid container for testing a bacterium such as virus. More detailedly, it relates to a specimen sampling liquid container having a structure capable of protecting a technician from a risk of contamination and infection by a virus, such as influenza, when a sampling liquid to be dripped into a reaction reagent container for detecting the virus is prepared.

### BACKGROUND ART

As one of virus antigen tests such as for influenza, in recent years, there is used an influenza antigen test kit in which a test can be performed at a bed side. Additionally, with the test kit it becomes possible to rapidly detect also a judgment as to A-type/B-type of the influenza. In a test kit like this, there is generally utilized an immuno-chromatography method, a flow-through method, an EIA method, or the like. In each of these methods, a sampling liquid prepared from a specimen previously collected from a patient is dripped into a reaction reagent container, e.g., a reaction reagent cassette. Concretely, after a mucus is sucked by a suction device from a nasal cavity or pharynx of a patient or is wiped by a swab, it is dissolved by a dissolving solution to thereby prepare the sampling liquid, and this sampling liquid is dripped into the reaction reagent container.

As a container for preparing a sampling liquid like this, it is possible to enumerate one in which the sampling liquid is dripped by replacing a cap of a capped container previously filled with a dissolving solution with a drip port cap (JP-A-2004-109015 Gazette). For example, a specimen treatment liquid is first prepared in a squeeze tube, and next the specimen is treated by immersing a swab on which the specimen is collected into the specimen treatment liquid, thereby preparing the sampling liquid. Additionally, after the squeeze tube is fitted with a drip chip (drip port cap) and is reversed, the sample is then dripped into a specimen drip part of the reaction reagent container from the drip chip (drip port cap).
Patent Document 1: JP-A-2004-109015

### DISCLOSURE OF THE INVENTION

### Problems that the Invention is to Solve

In the container of the above type, the specimen sampling liquid container can be made directly into a dripping container, and it is possible to drip, from a first drop, a liquid uniformly extracted, in which fluctuation in every specimen is small. Further, if a filter is attached to the drip chip (drip port cap), clogging does not occur even if a pus whose viscosity is high or solid matter is contained in the specimen. However, in this case, if the drip chip (drip port cap) is small when it is attached, or the like, a risk that the technician is infected by the virus becomes extremely high.

Further, in a case where there is not an exclusive cap attached to the drip port, when discarding the container after the dripping, the sampling liquid spreads in the discarded container, so that the risk of the infection becomes high also on the occasion of waste disposal. Additionally, there follows such cumbersome work that the same amount of drip port caps as the number of the specimens must be separately, previously prepared. Whereupon, an object of the present invention is to provide a sampling liquid container in which there is solved the drawbacks of the user's contamination and risk of infection by the virus, and cumbersome handling.

### Means for Solving the Problems

As a result of earnestly performing various studies in order to solve the above problems, the present inventors found a specimen sampling liquid container which has a cap made to serve as a drip tip (drip port cap) and can be used to immediately drip sampling liquid by a series of operations for attaching the cap after a sampling liquid is prepared, and arrived at the present invention.

Thus, the present invention relates to a specimen sampling liquid container comprising a tubular container where an upper end is open and a bottom is closed, a sealing member closing the opening of the tubular container and a cap which is engaged with the upper end of the tubular container at a first position, moves from the first position to a second position, has a drip port at the upper end and has a part which releases the sealing member beneath the drip port. The cap is desired to have the sealing member (which includes a closing means) inserted therein.

When the cap is moved from the first position to the second position, the sealing member which closes the opening of the tubular container is released whereby the drip port of the cap and the tubular container are connected. Further, the tubular container and the cap are screw-engaged and locked.

The specimen sampling liquid container of the present invention is provided with a filter which is adjacent to the drip port for trapping a highly viscous liquid. In addition, the specimen sampling liquid container of the present invention is equipped with a cap for the drip port which is freely attachable/detachable.

### ADVANTAGES OF THE INVENTION

The specimen sampling liquid container of the present invention has a cap having a seal member inserted therein and is provided with a drip port, whereby it is now possible to avoid the risk of pollution and infection of a technician by a virus during preparation of a dropping (or dripping) liquid to be dripped into a reaction reagent container. It is also possible to reduce the troublesomeness of the operation of the sampling liquid container. Especially due to the fact that, at the upper end of a tubular container, a cap is engaged at a first position and is slid or moved from the first position to a second position to release a sealing member whereby the drip port of the cap and the tubular container are connected, preparation of a drip chip is unnecessary since a liquid flow path is formed by the same series of operations as compared with the case where the conventional specimen sampling liquid container is just used as a drip container. In addition, the specimen sampling liquid container of the present invention is not limited for use for a virus test such as an influenza virus but is able to be utilized for general biological tests including other pathogenic microbes.

### BRIEF DESCRIPTION OF THE DRAWINGS

FIG. 1 is a longitudinal cross-sectional view showing the specimen sampling liquid container of the present invention before use.

FIG. 2 is a side view showing the specimen sampling liquid container of the present invention before use.

FIG. 3 is a longitudinal cross-sectional view showing the specimen sampling liquid container of the present invention where a swab collected sample is inserted from an opening.

FIG. 4 is a brief drawing which shows the specimen sampling liquid container of the present invention where a closing means is detached from a sealing member by a projection means and is dropped into a tubular container.

FIG. 5 is a brief drawing which shows the specimen sampling liquid container of the present invention where the sampling liquid is dripped from a drip port.

FIG. 6 is a longitudinal cross-sectional view showing another specimen sampling liquid container of the present invention before use.

FIG. 7 is a side view showing the specimen sampling liquid container of FIG. 6 before use.

FIG. 8 is a longitudinal cross-sectional view showing still another specimen sampling liquid container of the present invention before use.

### DESCRIPTION OF THE REFERENCE NUMERALS AND SIGNS

1 specimen sampling liquid container
2 tubular container
21 flange
3 sealing member
4 cap
41 projection
44 extended part
45 flange engaging part
46 cut part by shearing force
47 covering member
48 perforation for cutting
49 seal
5 drip port cap
6 filter
7 dissolving liquid chamber
8 collecting rod

### BEST MODE FOR PRACTICING THE INVENTION

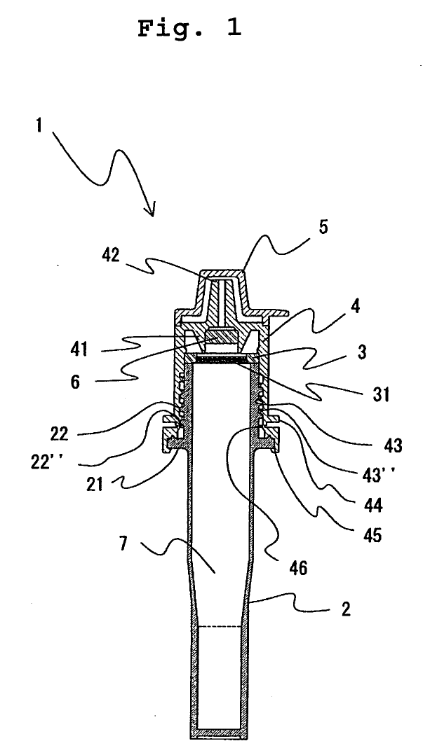

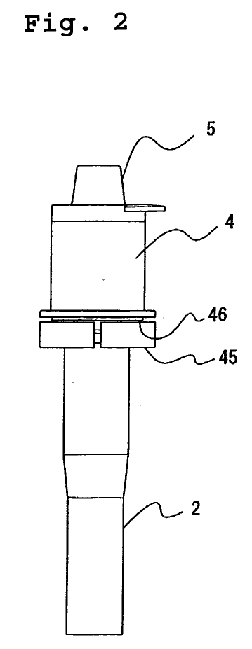

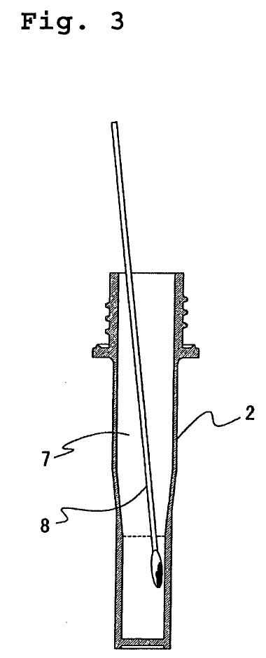

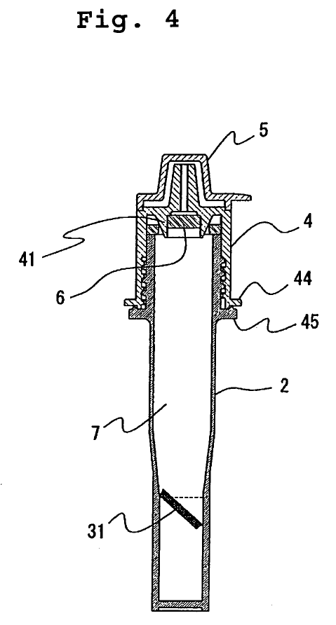

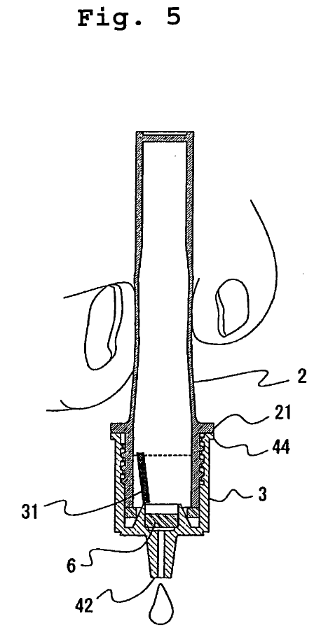

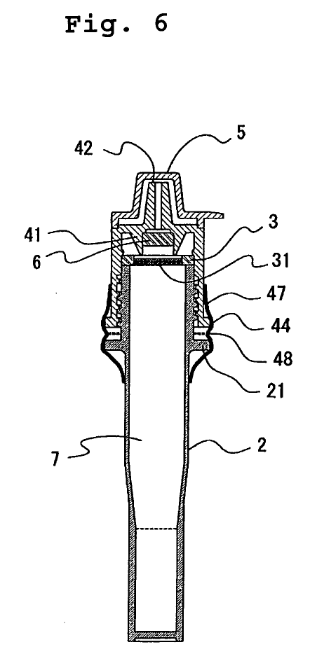

The specimen sampling liquid container of the present invention is specifically illustrated by referring to the drawings. FIG. 1 is a longitudinal cross-sectional view of an embodiment of the specimen sampling liquid container of the present invention and FIG. 2 is a side view of the specimen sampling liquid container of the present invention as shown in FIG. 1. FIG. 3 is a longitudinal cross-sectional view showing the state where a cap has been removed from the specimen sampling liquid container of the present invention and a swab collected sample is inserted into an opening. FIG. 4 is a brief drawing which shows the state where a cap of the specimen sampling liquid container of the present invention shown in FIG. 1 is moved (downward) from a first position to a second position and a closing means is detached from a sealing member by a projection and dropped into a tubular container. FIG. 5 is a brief drawing which shows the state where a sampling liquid is dripped from a drip port. FIGS. 6 to 8 show longitudinal views of other closing means in the specimen sampling liquid container of the present invention.

As shown in FIG. 1, the specimen sampling liquid container 1 of the present invention comprises a tubular container 2 where an upper end is open and a bottom is closed, a sealing member 3 closing the opening of the tubular container 2, and a cap 4 which is engaged with the upper end of the tubular container 2 at a first position, is movable from the first position to a second position, has the above sealing member 3 inserted thereinto, has a drip port 42 at the upper end and has a part 41 which releases the above sealing member 3 beneath the drip port 42.

In the tubular container 2, there is formed a dissolving liquid chamber 7 by the sealing member 3 which is slidably inserted into the cap 4 and is adjacent to the upper end of the tubular container 2.

In the tubular container 2, the attachable/detachable cap 4 is slidably attached on its upper end and usually screw-engaged. Therefore, the tubular container 2 has an opening at its upper end, onto which the cap 4 is able to be screwed. In the cap 4, the sealing member 3 is slidably attached in the cap 4 and is adjacent to the upper end of the tubular container 2. As a result of attaching the cap 4 and the sealing member 3, a dissolving liquid chamber 7 is formed in the tubular container 2. A liquid which can dissolve a sample (such as a wiped liquid of the nasal cavity, sucked liquid of the nasal cavity and wiped liquid of the pharynx) is filled in the dissolving liquid chamber 7. Usually, a dissolving liquid is water and a surfactant is added thereto so as to enhance the reactivity of a sample when dripped into a reaction reagent. Further, sodium azide or the like is added thereto as a preservative.

In order to squeeze out a sampling liquid treated in the tubular container 2 from an opening, the tubular container 2 is pressed from the outside and a gas in the dissolving liquid chamber 7 is compressed so as to increase the inner pressure. Accordingly, it is preferred that the tubular container 2 has transparency and flexibility by which the state in the container is able to be confirmed and the container is able to revert to its original shape without whitening even by repeated compressions and, as the material of the container, polyethylene, polypropylene, vinyl chloride resin, polybutadiene, etc. are advantageously used.

Since the cap 4 and the sealing member 3 are assembled while keeping liquid tightness of the dissolving liquid chamber 7 in the tubular container 2, there is no risk that the dissolving liquid leaks out from the tubular container 2.

The cap 4 is attached to the tubular container 2 in a freely attachable/detachable and sliding manner and, usually, it is screw-engaged thereto. Further, since it slides while keeping the liquid tightness, it is adjacent to the female screw on the surface of the lower area and the upper area of it can be attached firmly to the inner wall of the open end of the tubular container 2. The drip port 42 is formed on the upper end and, upon dripping, a collected sampling liquid squeezed out by pressure applied to the tubular container 2 is able to be quantitated and discharged.

As a material for the cap 4, polyethylene, polypropylene, polymethylpentene, ABS resin, polystyrene, BS resin, polycarbonate resin, etc. are used.

Usually, the sealing member 3 which closes the opening of the tubular container 2 has such a shape that liquid tightness is not deteriorated during manufacture and storage for a long period and, preferably, has a disk shape of a small thickness and, before the sample is added to the container, it is tightly attached to the inner wall of the cap 4. When the cap 4 is firstly detached from the tubular container 2, the sealing member 3 is connected to the cap. However, when the cap 4 is attached to the tubular container 2 again and moves from the first position to the second position, the sealing member 3 also moves in the direction of the cap 4 (from the first position to the second position) and a closing means 31 is released by the projection 41 equipped in the cap 4 so that a passage through which the liquid passes is formed. This passage is not closed even when the deformation of the dissolving liquid chamber 7 in the tubular container 2 is reverted. Accordingly, it is preferred that the sealing member 3 has flexibility of such an extent that the liquid tightness to the cap 4 is maintained during the movement for releasing the closing means 31. As a material of the sealing member 3, there may be used polyethylene, polypropylene and hard vinyl chloride resin as well as nitrile rubber which is an elastic substance and has a relatively high hardness.

It is sufficient that the closing means 31 is attached to the sealing member 3 in a state of liquid tightness and any of a weak adhesion by deposition which is easily exfoliated, a connection in a state of being pushed therein and an assembly of being compressed with an elastic substance is acceptable. With regard to a material of the closing means 31, polyethylene, polypropylene, vinyl chloride resin and polybutadiene resin as well as nitrile rubber, thermoplastic elastomer, etc. or a resin compounded of these may be used or a blended resin comprising two or more components of a raw material for the sealing member may be used.

In an inner area of the cap 4, a filter 6 is installed at the lower area which is adjacent to the drip port 42. When the sample collected from a patient is highly viscous or contains a solid substance, the filter 6 has such a porosity that the above is trapped so that the drip port 42 is not clogged. An effective area for the filtration and the degree of the filter mesh can be freely selected. As such a material, polyethylene, polypropylene, fluorine resin, Nylon resin, etc. as well as inorganic materials or the like may be used and, usually, a sintered polyethylene is used.

On the drip port 42, a cap 5 for the drip port which is able to be freely attached and detached thereto is equipped. The cap 5 for the drip port may be attached to the drip port 42 in a freely attachable and detachable manner and, as a raw material therefor, polyethylene, polypropylene, vinyl chloride resin, etc. may be used. The drip port 42 may also be formed integral with the cap 5 for the drip port. It is also possible that a diameter of an exclusive container stand is made nearly the same as the diameter of the tubular container 2 whereby plural specimen sampling liquid containers are able to be placed into the exclusive container stand.

The specimen sampling liquid container 1 of the present invention will be more specifically explained by referring to FIG. 1. Thus, a specimen sampling liquid container comprises the tubular container 2 which has a bottom where the upper end is opened, plural male screws 22 on the upper outer surface, space in the upper part of the uppermost male screw, and a flange 21 in the outer circumferential direction of the lower area of the lowermost male screw 22″; the sealing member 3 equipped at the upper end part of the tubular container 2, which has the closing means 31 having a smaller size than the inner circumference of the upper end part of the tubular container 2 at its center; cylindrical cap 4 attached movably to the upper end of the above tubular container 2 in a freely attachable/detachable manner, and which has the above sealing member 3 inserted therein, drip port 42 at upper end, nearly circular ring-shaped projection 41, which is smaller than the above closing means 31 at the lower end of the drip port 42, plural female screws 43 screw-engaged to the above male screw 22 on the inner surface of the lower part, a space at the upper area of the uppermost female screw, extended part 44 extending in an outer direction beneath the lowermost female screw 43″, a part 45 engaged with the above flange part 21 and a part 46 which can be cut by a shearing force intermediate the extended part 44 and the flange engaging part 45.

The part 46 which can be cut by the shearing force is preferred to be a plurality of bridges which are thinly formed between the above flange engaging part 45 and the above extended part 44.

The cylindrical cap 4 is rotated and moves upward and, when the part 45, which is engaged to the above flange 21, and the part 46, which is cut by being subjected to a shearing force between the above extended part 44 and the above flange engaging part 45, are cut off, the cylindrical cap 4 is removed together therewith.

After rotating a predetermined angle, the above cylindrical cap 4 is moved downward (from the first position to the second position), the closing means 31 is detached from the sealing member 3 by the projection 41, the projection 41 is engaged with the sealing member 3 and the above extended part 44 is engaged with the flange part 21.

In preparing a specimen sampling liquid, the cap 4 is firstly removed from the tubular container 2, the opening is open under a state where the cap 4 opens upwards and a collecting rod 8 such as a swab to which the sample collected from the patient is adhered is inserted into the dissolving liquid chamber 7 of the tubular container 2 from the opening at the upper end so that the sample is dissolved in the dissolving liquid whereupon a sampling liquid is prepared (FIG. 3). After that, the cap is attached again and, when the cap 4 is moved from the engaged first position to the second position, the closing means 31 of the sealing member 3 is detached and caused to drop by the projection 41 formed in the cap 4 whereupon a passage through which the liquid passes is formed (FIG. 4).

Then the container 1 is turned upside down and, after the drip port 42 of the container 1 is pointed toward a reaction reagent container (not shown in the drawing), a trunk portion where the dissolving liquid chamber 7 of the tubular container 2 is located is compressed whereupon, due to an increase in the inner pressure caused by the compression, the sampling liquid in the dissolving liquid chamber 7 is dripped from the drip port 42 (FIG. 5).

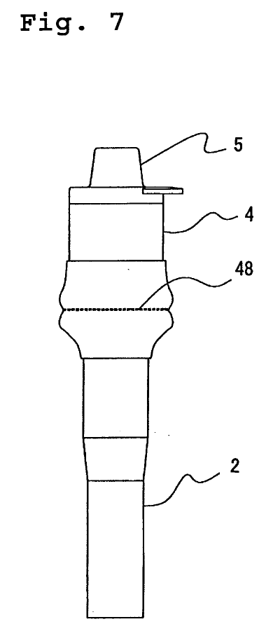

In another embodiment of the present invention, the flange part 21 is formed at the lower outside of the above tubular container 2, the extended part 44 is formed at the lower outside of the cap 4 and the extended part 44 and the flange part 21 are aligned with a gap as shown in FIG. 6. A covering member 47 covers the above flange part 21 of the tubular container 2 and the extended part 44 of the cap 4 by straddling these and being engaged in the first position. It is preferred that a perforation 48 is formed on the part covering the above gap so that breaking of the covering member takes place easily (FIG. 7). As to the material of the covering member 47, a film of polypropylene, polyvinylidene chloride, polyethylene terephthalate, etc. may be used. This covering member 47 is cut when an upward sharing force is applied upon its detachment by rotation of the cap 4. As is the same as in the case of the specimen sampling liquid container shown in FIG. 1, the cap 4 moves from the first position where it is engaged to the second position as a result of rotation of the cap 4 and the closing means 31 of the sealing member 3 is detached and dropped by the projection 41 formed in the cap 4 whereupon a passage through which a liquid passes is formed.

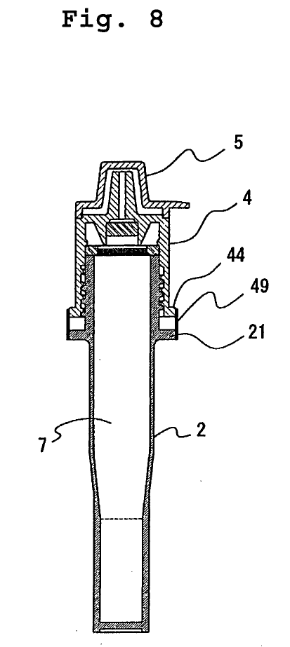

In still another embodiment of the present invention, the flange part 21 is formed on the lower outside of the tubular container 2, the extended part 44 is formed at the lower outside of the cap 4 and the extended part 44 and the flange part 21 are aligned with a gap as shown in FIG. 8. A seal 49 covers the above flange part 21 of the tubular container 2 and the extended part 44 of the cap 4 by straddling these parts and is engaged in the first position. As to the seal 49, polypropylene, vinyl chloride, polyethylene terephthalate, paper and a multi-layered sheet using these as a base material, which are coated with a tackifier or an adhesive, may be used. The seal 49 is peeled off when the cap 4 is detached. As is the same as in the case of the specimen sampling liquid container shown in FIG. 1, the cap 4 moves from the first position where it is engaged to the second position as a result of rotation of the cap 4 and the closing means 31 of the sealing member 3 is detached and dropped by the projection 41 formed in the cap 4 whereupon a passage through which a liquid passes is formed.

In the specimen sampling liquid container mentioned hereinabove, although the sealing member 3 is inserted into the cap 4, it is also acceptable that the sealing member 3 is not inserted into the cap 4 but is joined to the tubular container 2. In preparing the sampling liquid in such case, the cap 4 is firstly moved from the engaged first position where it is engaged to the second position and the closing means 31 of the sealing member 3 is detached and dropped by the projection 41 formed in the cap 4 so that a passage for passing the liquid therethrough is formed. After that, the cap 4 is detached from the tubular container 2, the opening is opened when the cap 4 is in an upward state, a collecting rod 8 such as a swab to which the sample collected from the patient is adhered is inserted into a dissolving liquid chamber 7 of the tubular container 2 from the opening of the upper end and the sample is dissolved in a dissolving liquid to prepare a collected sample liquid. Then the cap is attached again and the specimen sampling liquid is discharged from the drip port 42.

1. A specimen sampling liquid container comprising a tubular container where an upper end is open and a bottom is formed, a sealing member closing the opening of the tubular container and a cap which engages to the upper end of the tubular container at a first position, slides from the first position to a second position, has a drip port at the upper end and has a part which releases the above sealing member beneath the drip port.

2. The specimen sampling liquid container according to claim 1, wherein the sealing member is inserted into the cap.

3. The specimen sampling liquid container according to claim 1, wherein the sealing member is joined to the opening of the tubular container.

4. The specimen sampling liquid container according to claim 1, wherein, when the cap slides from the first position to the second position, the sealing member closing the opening of the tubular container is released whereupon the drip port of the cap and the tubular container are communicated.

5. The specimen sampling liquid container according to claim 1, wherein the tubular container and the cap are screw-engaged.

6. The specimen sampling liquid container according to claim 1, wherein a flange part is formed in the lower outside of the tubular container, and an extended part, a part which is engaged to the flange part and a part which is cut by a shearing force between the extended part and the flange engaged part are formed at lower outside and are engaged at the first position.

7. The sampling liquid container according to claim 1, wherein a flange part is formed at the lower outside of the tubular container, an extended part is formed at the lower outside of the screw part of the cap, the extended part and the flange part are aligned with a gap and a covering member covers the above flange part of the tubular container and the extended part of the cap by straddling these being engaged in the first position.

8. The specimen sampling liquid container according to claim 1, wherein, in an inner cavity of the cap, a filter is installed adjacently and beneath to the drip port.

9. The sampling liquid container according to claim 1, wherein a cap for a drip port is attached to the drip port in a freely attachable/detachable manner.
